(19) United States
(12) Patent Application Publication
(10) Pub. No.: US 2018/0011840 A1
(43) Pub. Date: Jan. 11, 2018

(54) TRANSLATION APPARATUS, TRANSLATION SYSTEM, AND NON-TRANSITORY COMPUTER READABLE MEDIUM

(71) Applicant: FUJI XEROX CO., LTD., Tokyo (JP)

(72) Inventor: Yasushi ITO, Kanagawa (JP)

(73) Assignee: FUJI XEROX CO., LTD., Tokyo (JP)

(21) Appl. No.: 15/441,335

(22) Filed: Feb. 24, 2017

(30) Foreign Application Priority Data
Jul. 7, 2016 (JP) 2016-134715

(51) Int. Cl. G06F 17/28; G10L 15/00; G06K 9/00

(52) U.S. Cl. CPC G06F 17/289; G06K 9/00449; G06F 17/2836; G10L 15/005

(57) ABSTRACT

A translation apparatus includes a translation unit which translates content of a document into a different language, a history creating unit which, in translation of the content from a first language into a second language, creates history information including a correspondence between original text in the first language and translated text in the second language, an extraction unit which, in translation of the content from the second language into another language, if content (present content) of the document in the second language is present in the history information, extracts content (absent content) that is not present in the history information, and a combining unit which combines a translation result obtained by translating the present content from the second language into the other language, with a replacement result obtained by replacing the absent content from the second language to the other language based on the history information.

### CROSS-REFERENCE TO RELATED APPLICATIONS

This application is based on and claims priority under 35 USC 119 from Japanese Patent Application No. 2016-134715 filed Jul. 7, 2016.

### BACKGROUND

### (i) Technical Field

The present invention relates to a translation apparatus, a translation system, and a non-transitory computer readable medium.

### (ii) Related Art

Recently, translation service for translating a paper document or an electronic document that is written in an original language into another language is provided. The translation service is provided, for example, as a cloud service. In this service, original text is transmitted from a terminal apparatus or the like to a cloud server that provides translation service, and translated text after translation are returned back.

### SUMMARY

According to an aspect of the invention, there is provided a translation apparatus including a translation unit, a history creating unit, an extraction unit, and a combining unit. The translation unit translates content of a document into a different language. When the translation unit translates the content of the document from a first language into a second language, the history creating unit creates history information including a correspondence between original text in the first language and translated text in the second language. When the translation unit is to translate the content of the document from the second language into another language, if content of the document written in the second language is present in the history information, the extraction unit extracts content that is not present in the history information. The combining unit combines a result of translation with a result of replacement. The result of translation is obtained by the translation unit translating the content that is not present in the history information. The translating is performed from the second language into the other language. The result of replacement is obtained by replacing the content that is present in the history information. The replacing is performed from the second language to the other language on the basis of the history information.

### BRIEF DESCRIPTION OF THE DRAWINGS

Exemplary embodiment of the present invention will be described in detail based on the following figures, wherein:

FIG. 1 is a diagram illustrating an exemplary overall configuration of a translation system to which an exemplary embodiment of the present invention is applied;

FIG. 2 is a diagram illustrating the hardware configuration of a terminal apparatus;

FIG. 3 is a diagram illustrating an exemplary hardware configuration of an image forming apparatus;

FIG. 4A is a diagram illustrating an exemplary document transmitted by using a facsimile;

FIG. 4B is a diagram illustrating an exemplary document that has been translated by a cloud server;

FIG. 4C is a diagram illustrating an example obtained by a user adding information for necessary items to the document after translation;

FIG. 4D is a diagram illustrating an example obtained by retranslating the document after the addition illustrated in FIG. 4C, again from Japanese into English;

FIG. 5 is a block diagram illustrating an exemplary functional configuration of the cloud server;

FIG. 6 is a flowchart for describing operations in the translation system;

FIG. 7 is a diagram illustrating the result of analysis of the layout of a document which is performed by a layout analyzing unit;

FIG. 8 is a diagram illustrating exemplary history information created by a history creating unit;

FIG. 9A is a diagram illustrating the result of reanalysis of the layout of a document which is performed by the layout analyzing unit;

FIG. 9B is a diagram illustrating a difference detected by an extraction unit;

FIG. 10 is a diagram illustrating an exemplary piece of history information which indicates a difference and which is created by the history creating unit; and

FIG. 11 is a diagram illustrating an exemplary piece of history information obtained after the history creating unit adds a translation result.

### DETAILED DESCRIPTION

Description about the Overall Configuration of a Translation System

An exemplary embodiment of the present invention will be described in detail below with reference to the attached drawings.

In the description below, an “original language” is a language from which translation is performed, and a language before translation. A “translation language” is a language after translation. Further, “original text” is text containing one or more characters (words) in an original language. “Translated text” is text containing one or more characters (words) in a translation language.

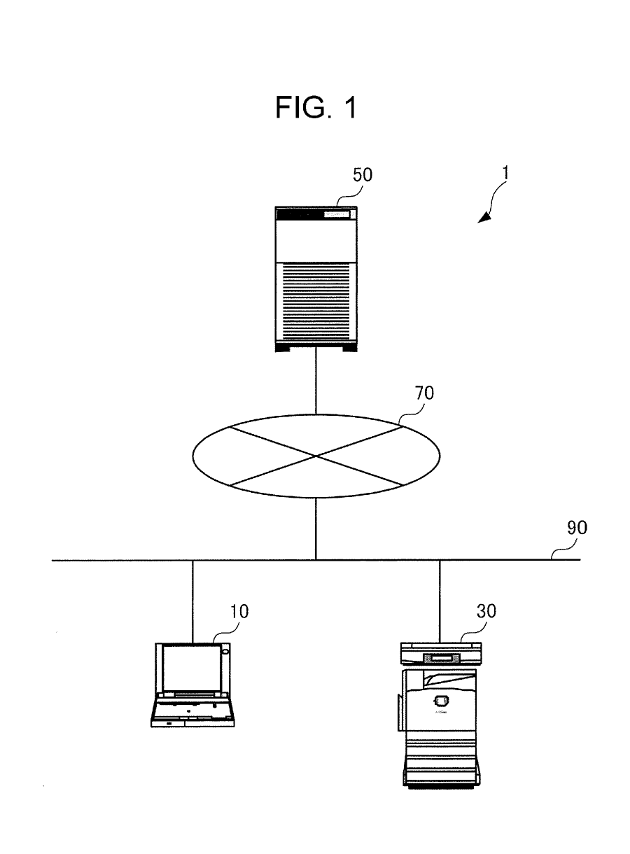

FIG. 1 is a diagram illustrating an exemplary overall configuration of a translation system to which the exemplary embodiment is applied.

As illustrated in FIG. 1, a translation system 1 includes a terminal apparatus 10 and an image forming apparatus 30 which are connected to a network 90. The network 90 is connected to a network 70, for example, through a gateway server (not illustrated), and a cloud server 50 is connected to the network 70.

FIG. 1 illustrates only one terminal apparatus 10. Alternatively, multiple terminal apparatuses 10 may be provided. FIG. 1 also illustrates only one image forming apparatus 30. Alternatively, multiple image forming apparatuses 30 may be provided.

The terminal apparatus 10 is a computer apparatus that requests the cloud server 50 to translate a document. As the terminal apparatus 10, a personal computer (PC), a portable terminal, a cellular phone, or the like may be used.

The image forming apparatus 30 forms an image on a recording medium such as paper, and outputs the recording medium as a print medium. The image forming apparatus 30 is provided with a printer function. In addition to this, the image forming apparatus 30 may be provided with other image processing functions, such as a scanner function and a facsimile function.

The image forming apparatus 30 may request the cloud server 50 to translate a document, which will be described in detail below. The image forming apparatus 30 serves as a document transmitting section that transmits, to the cloud server 50, document data of a document written in an original language.

The cloud server 50 is a server computer that provides a cloud service for translation. The cloud server 50 serves as a translation section (translation apparatus) that translates the content of a document.

The network 70 that is a communication unit used in information communication between the terminal apparatus 10 and the cloud server 50 and in information communication between the image forming apparatus 30 and the cloud server 50 is, for example, the Internet.

The network 90 that is a communication unit used in information communication between the terminal apparatus 10 and the image forming apparatus 30 is, for example, a local area network (LAN).

The hardware configuration of the terminal apparatus 10 will be described.

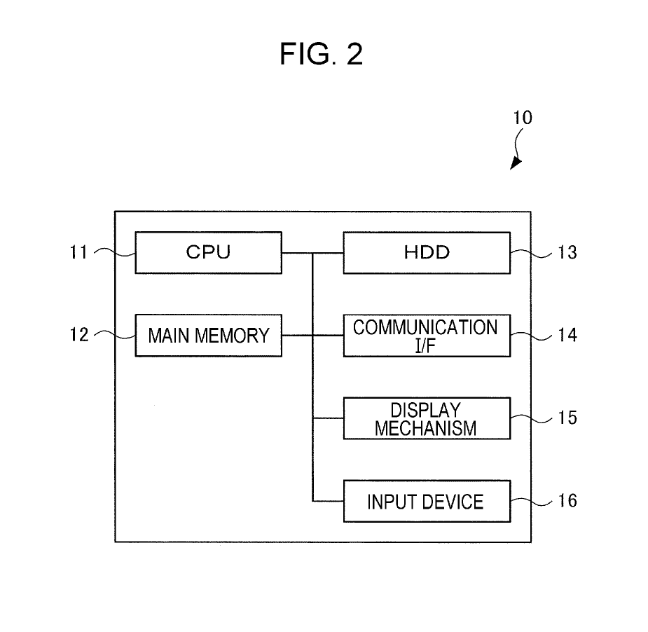

FIG. 2 is a diagram illustrating the hardware configuration of the terminal apparatus 10.

As illustrated in FIG. 2, the terminal apparatus 10 includes a central processing unit (CPU) 11 that is a calculating unit, and also includes a main memory 12 and a hard disk drive (HDD) 13 that are storages. The CPU 11 executes various types of software, such as an operating system (OS) and an application. The main memory 12 is a memory area used to store the various types of software, data used in their execution, and the like. The HDD 13 is a memory area used to store input data for the various types of software, output data from the various types of software, and the like.

Further, the terminal apparatus 10 includes a communication interface (hereinafter denoted as a “communication I/F”) 14 for communicating with the outside, a display mechanism 15 constituted by a video memory, a display, and the like, and an input device 16, such as a keyboard and a mouse.

FIG. 2 may be grasped as a diagram illustrating the hardware configuration of the cloud server 50.

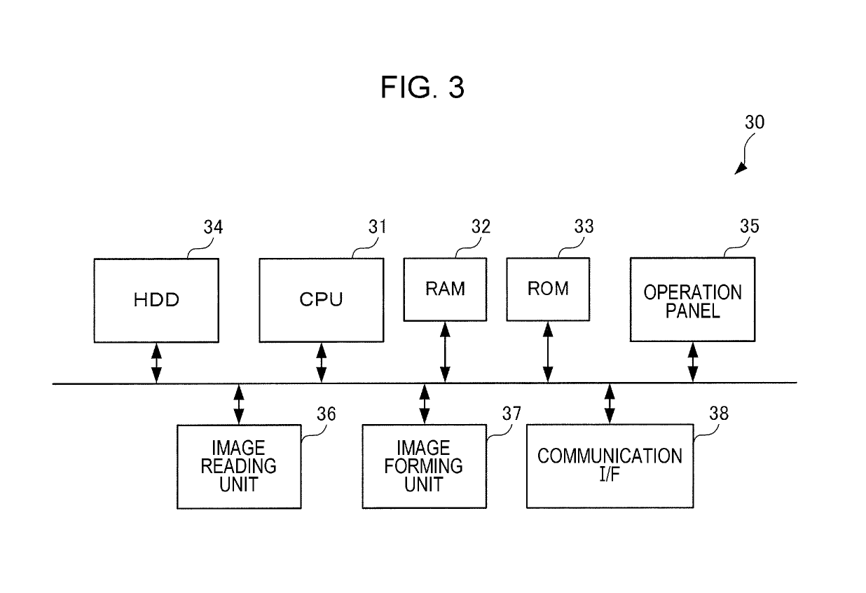

FIG. 3 is a diagram illustrating an exemplary hardware configuration of the image forming apparatus 30.

As illustrated in FIG. 3, the image forming apparatus 30 includes a CPU 31, a random access memory (RAM) 32, a read only memory (ROM) 33, a hard disk drive (HDD) 34, an operation panel 35, an image reading unit 36, an image forming unit 37, and a communication I/F 38.

The CPU 31 loads various programs stored in the ROM 33 or the like, into the RAM 32 and executes the programs so as to implement the functions described below.

The RAM 32 is a memory used as a work memory or the like of the CPU 31.

The ROM 33 is a memory used to store the various programs and the like executed by the CPU 31.

The HDD 34 is, for example, a magnetic disk device that stores image data which is read by the image reading unit 36, image date used in image formation performed by the image forming unit 37, and the like.

The operation panel 35 is, for example, a touch panel that displays various types of information and that receives an operation input from a user.

The image reading unit 36 reads an image recorded on a document. The image reading unit 36 is, for example, a scanner. As a scanner, a charge coupled device (CCD) system or a contact image sensor (CIS) system may be used. In the CCD system, light obtained by reflecting light emitted from a light source to a document is condensed by using a lens, and the condensed light is received by a CCD. In the CIS system, light obtained by reflecting light that is emitted from a light-emitting-diode (LED) light source to a document while moving is received by a CIS.

The image forming unit 37 is an exemplary print mechanism that forms an image on a recording medium. The image forming unit 37 is, for example, a printer. As a printer, an electrophotographic system or an inkjet system may be used. In the electrophotographic system, toner attached to a photoreceptor is transferred to a recording medium so that an image is formed. In the inkjet system, ink is ejected onto a recording medium so that an image is formed.

The communication I/F 38 receives/transmits various types of information from/to other apparatuses through a network.

In the configuration of the translation system 1, the terminal apparatus 10 transmits document data in an original language before translation to the cloud server 50. For example, this transmission may be performed by using software such as a web browser operated on the terminal apparatus 10. Specifically, this transmission is performed by displaying, on the display mechanism 15 of the terminal apparatus 10, a web page for a cloud service provided by the cloud server 50 and using the input device 16 to operate a menu or the like on the web page. The cloud server 50 translates the document from the original language into a translation language, and returns the document after translation back to the terminal apparatus 10. The terminal apparatus 10 displays, on a web page, the document after translation which has been returned back. For example, the Word format or the Portable Document Format (PDF) format may be used as the format of document data.

Not only the terminal apparatus 10 but also the image forming apparatus 30 may transmit document data in an original language to the cloud server 50. In this case, for example, the image reading unit 36 is used to scan a document, and image data of an image recorded on the document is obtained. The image data of the document is converted into document data in a format such as the PDF format, and the document data is transmitted to the cloud server 50.

After the cloud server 50 translates the document from the original language into a translation language, the cloud server 50 returns the document data after translation back to the image forming apparatus 30 or the terminal apparatus 10. When the document data after translation is returned back to the image forming apparatus 30, the image forming apparatus 30 displays the document after translation, for example, on the operation panel 35. Alternatively, the document may be stored in the HDD 34. When the document is returned back to the terminal apparatus 10, similarly to the above-described case, the document after translation is displayed on a web page.

An example in which a document that has been transmitted by using a facsimile is used in the translation system 1 will be described.

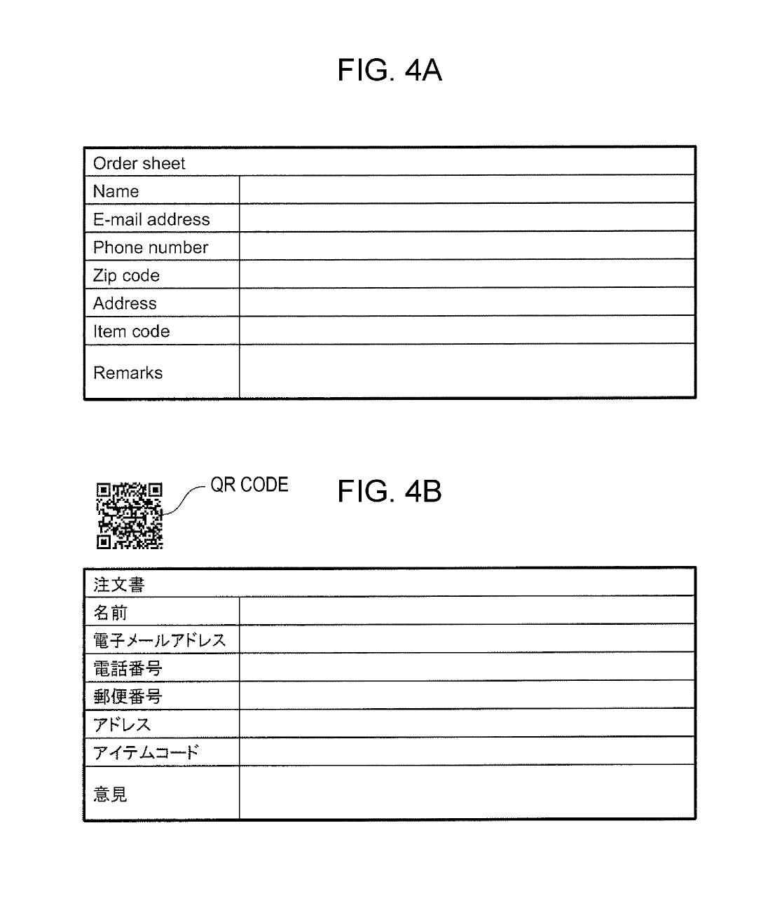

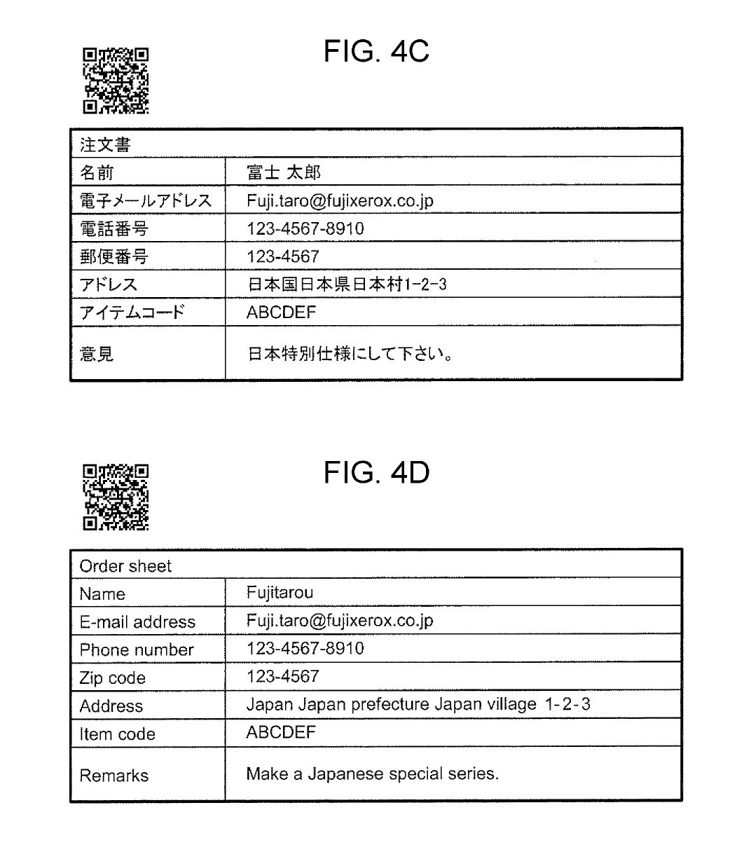

FIG. 4A illustrates an exemplary document that has been transmitted by using a facsimile.

The document illustrated in FIG. 4A is an order sheet, and contains text in English. In this case, “Order Sheet” indicating the name of the document is described at the top. On the left side of a lower portion of the document name, “Name”, “E-mail address”, “Phone number”, “Zip code”, “Address”, “Item code”, and “Remarks” which indicate necessary items for placing an order are described. Blank fields for writing actual information corresponding to these items are provided on the right side of the lower portion.

A user scans the document by using the image reading unit 36 of the image forming apparatus 30, and transmits, to the cloud server 50, the document data whose format is the PDF format or the like. As a result, the cloud server 50 translates the content of the document before translation, which is illustrated in FIG. 4A, from English, which is an original language, into Japanese, which is a translation language. The cloud server 50 returns the document after translation, as document data to the image forming apparatus 30.

FIG. 4B illustrates an exemplary document translated by the cloud server 50.

As illustrated in FIG. 4B, “Order Sheet” representing the document name described at the top of the document is translated into “ [symbol] ” (Order sheet). In addition, “Name”, “E-mail address”, and the like which indicate necessary items for placing an order and which are described on the left side of the portion under the document name are translated into “ [symbol] ” (Name), “ [symbol] ” (E-mail address), “ [symbol] ” (Phone number), “ [symbol] ” (Zip code), “ [symbol] ” (Address), “ [symbol] ” (Item code), and “ [symbol] ” (Remarks).

The user adds information for the necessary items on the received document after translation. In this case, information for necessary items is written in the blank fields on the right side of the regions in which “Name”, “E-mail address”, and the like are described. At that time, the user may add handwritten information or may add information by using electronic data.

FIG. 4C is a diagram illustrating an example obtained by the user adding information for necessary items on the document after translation.

In this example, the user writes “ [symbol] ” (Taro Fuji) for “ [symbol] ” (Name). Similarly, the user writes “Fuji.taro@fujixerox.co.jp” for “ [symbol] ” (E-mail address); “123-4567-8910” for “ [symbol] ” (Phone number); “123-4567” for “ [symbol] ” (Zip code); “ [symbol] 1-2-3” (1-2-3 Japan Village, Japan Prefecture, Japan) for “ [symbol] ” (Address); “ABCDEF” for “ [symbol] ” (Item code); and “ [symbol] ” (Apply a specification specific to Japan) for “ [symbol] ” (Remarks).

Then, to return the document after the addition illustrated in FIG. 4C back to the transmission source of the fax, the user uses the translation system 1 again to retranslate the document from Japanese into English. Then, the user returns the document after retranslation which has been translated into English, by using a facsimile.

FIG. 4D is a diagram illustrating an example obtained by retranslating the document after the addition illustrated in FIG. 4C from Japanese into English.

In this example, “ [symbol] ” (Order sheet), “ [symbol] ” (Name), “ [symbol] ” (E-mail address), “ [symbol] ” (Phone number), “ [symbol] ” (Zip code), “ [symbol] ” (Address), “ [symbol] ” (Item code), and “ [symbol] ” (Remarks) which are Japanese text are returned back to “Order Sheet”, “Name”, “E-mail address”, “Phone number”, “Zip code”, “Address”, “Item code”, and “Remarks” which are described in the original English document. In addition, “ [symbol] ” (Taro Fuji), “Fuji.taro@fujixerox.co.jp”, “123-4567-8910”, “123-4567”, “ [symbol] 1-2-3” (1-2-3 Japan Village, Japan Prefecture, Japan), “ABCDEF”, and “ [symbol] ” (Apply a specification specific to Japan) which are added by the user are translated into “Fujitarou”. “Fuji.taro@fujixerox.co.jp”, “123-4567-8910”, “123-4567”, “Japan Japan prefecture Japan village 1-2-3”, “ABCDEF”, and “Make a Japanese special series.”, respectively.

If simple retranslation from Japanese into English is performed at that time, all of the text is subjected to retranslation. Therefore, the text in the original document is not always returned back to the original English text as illustrated in FIG. 4D. That is, when two translation operations, from English via Japanese into English, are performed, some pieces of text may not be returned back to their original English text. Specifically, “ [symbol] ” (Order sheet), “ [symbol] ” (Name), “ [symbol] ” (E-mail address), and the like are not always translated into “Order Sheet”, “Name”, “E-mail address”, and the like which are described in the original document. In this case, when the meaning of text in a document before translation which is transmitted from a transmission source is different from the meaning of text in the document in a retranslation language, or when translation accuracy is low, text may lose its original meaning. In this case, the transmission source has difficulty in understanding a document after retranslation which is returned back.

Description about the Cloud Server 50

In the exemplary embodiment, to aim at suppressing occurrence of this problem, the cloud server 50 has a configuration described below.

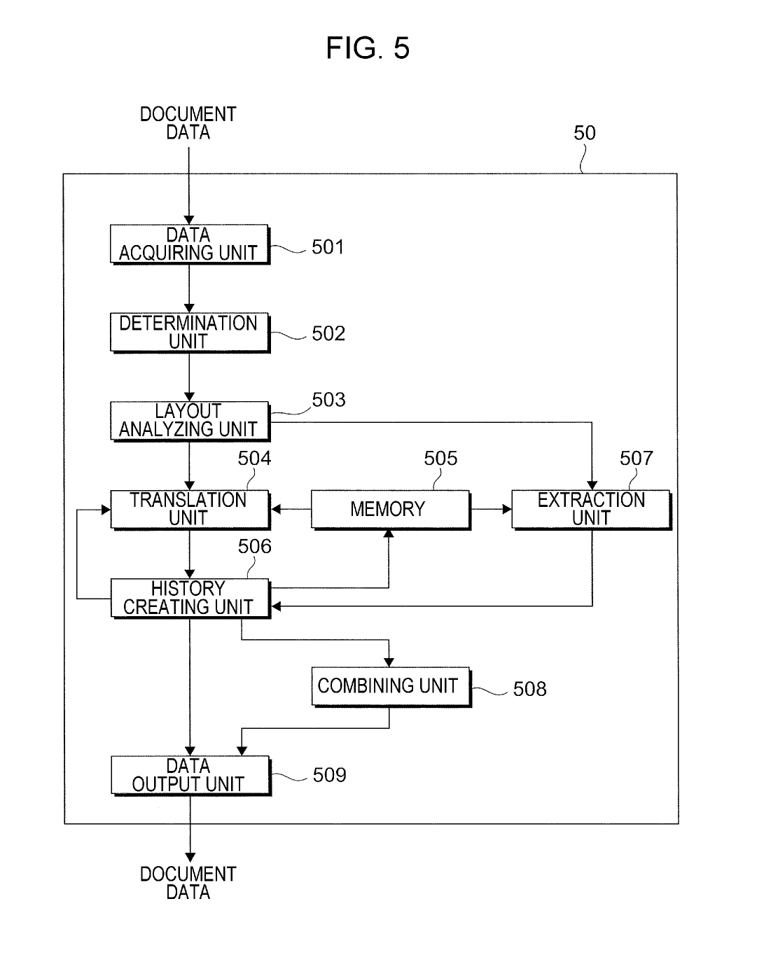

FIG. 5 is a block diagram illustrating an exemplary functional configuration of the cloud server 50. In FIG. 5, functions that are among various functions provided for the cloud server 50 and that are related to the exemplary embodiment are selected and illustrated.

As illustrated in FIG. 5, the cloud server 50 includes a data acquiring unit 501 that acquires document data of a document, a determination unit 502 that refers to history information which is a history of translation and that determines whether or not data corresponding to an obtained document is present, a layout analyzing unit 503 that analyzes the layout of a document, a translation unit 504 that translates original text so as to obtain translated text, a memory 505 that is used to store a translation dictionary and the history information, a history creating unit 506 that creates the history information, an extraction unit 507 that extracts predetermined text, a combining unit 508 that combines translation results with each other, and a data output unit 509 that outputs document data after translation.

The data acquiring unit 501 acquires document data of a document from the image forming apparatus 30. A description will be made below under the assumption that the data acquiring unit 501 acquires the document data of the document in English described in FIG. 4A.

The determination unit 502 determines whether or not data corresponding to the acquired document is present in the history information described below. In determination as to whether or not data corresponding to a document is present in the history information, for example, the determination unit 502 determines whether or not the acquired document contains a quick response (QR) code (registered trademark) indicating a piece of history information.

The layout analyzing unit 503 analyzes the layout of a document, and extracts regions. The method in which the layout analyzing unit 503 analyzes a layout will be described below.

The translation unit 504 translates the content of a document into a different language. The translation unit 504 uses the translation dictionary stored in the memory 505 to translate original text written in an original language so that translated text written in a translation language is obtained. In this case, the translation unit 504 translates English into Japanese, and translation is performed to obtain the text in Japanese which is described in FIG. 4B.

When the translation unit 504 translates the content of a document from a first language into a second language, the history creating unit 506 creates a piece of history information including translation results that are correspondences between original text in the first language and translated text in the second language. In this case, the first language is English, and the second language is Japanese. In the example illustrated in FIGS. 4A and 4B, links between “Order Sheet” and “ [symbol] ”, “Name” and “ [symbol] ”, “E-mail address” and “ [symbol] ”, “Phone number” and “ [symbol] ”, “Zip code” and “ [symbol] ”, “Address” and “ [symbol] ”, “Item code” and “ [symbol] ”, and “Remarks” and “ [symbol] ” are correspondences between original text in English and translated text in Japanese. The piece of history information includes the correspondences.

When the translation unit 504 translates the content of a document from the second language into another language, if content of the document in the second language is present in the history information, the extraction unit 507 extracts content of the document which is not present in the history information.

A description will be made by using the example in FIG. 4C. Text of “ [symbol] ” (Order sheet), “ [symbol] ” (Name), “ [symbol] ” (E-mail address), “ [symbol] ” (Phone number), “ [symbol] ” (Zip code), “ [symbol] ” (Address), “ [symbol] ” (Item code), and “ [symbol] ” (Remarks) is present in the history information as the content of the document in Japanese that is the second language. In contrast, text of “ [symbol] ” (Taro Fuji), “Fuji.taro@fujixerox.co.jp”, “123-4567-8910”, “123-4567”, “ [symbol] 1-2-3” (1-2-3 Japan Village, Japan Prefecture, Japan), “ABCDEF”, and “ [symbol] ” (Apply a specification specific to

Japan) which is added by a user is not present in the history information. Therefore, the extraction unit 507 extracts text, such as “ [symbol] ” (Taro Fuji) and “Fuji.taro@fujixerox.co.jp”, which is added by the user. That is, content that is not present in the history information corresponds to items added by a user on a document. The extraction unit 507 extracts the content that is not present in the history information, as difference on the basis of the position of text to be translated, which is obtained through analysis performed by the layout analyzing unit 503. The details will be described below.

The combining unit 508 combines a result of translation with a result of replacement. The result of translation is obtained by the translation unit 504 translating content that is not present in the history information, from the second language into a different language. The result of replacement is obtained by replacing content in the second language which is present in the history information, with content in the different language on the basis of the history information.

In this case, the result of translation which is obtained by the translation unit 504 translating content that is not present in the history information, from the second language (in this case, Japanese) into a different language (in this case, English) is “Fujitarou”, “Fuji.taro@fujixerox.co.jp”, “123-4567-8910”, “123-4567”, “Japan Japan prefecture Japan village 1-2-3”, “ABCDEF”, and “Make a Japanese special series.” which are illustrated in FIG. 4D. The result of replacement which is obtained by replacing content in the second language which is present in the history information, with that in the different language (in this case, English) on the basis of the history information is “Order Sheet”, “Name”, “E-mail address”, “Phone number”, “Zip code”, “Address”, “Item code”, and “Remarks”. That is, the result of translation is obtained through translation from Japanese text into English text, whereas the result of replacement is obtained without translation and the original English text is recovered on the basis of the history information. That is, text in the original document is not subjected to two translation operations, from English via Japanese into English, and is recovered on the basis of the history information. As a result, the document in English illustrated in FIG. 4D is obtained.

In the exemplary embodiment, the layout analyzing unit 503 that analyzes the layout of a document is provided so as to analyze the layout of a document. Accordingly, the translation unit 504 and the combining unit 508 may arrange a translation result while maintaining the layout obtained through analysis performed by the layout analyzing unit 503. As a result, a translation result may be obtained without disordering the layout of a document.

The data output unit 509 outputs data of a document after translation and data of a document after retranslation, as document data to the image forming apparatus 30.

Description about Operations of the Translation System 1

Operations performed in the translation system 1 will be described.

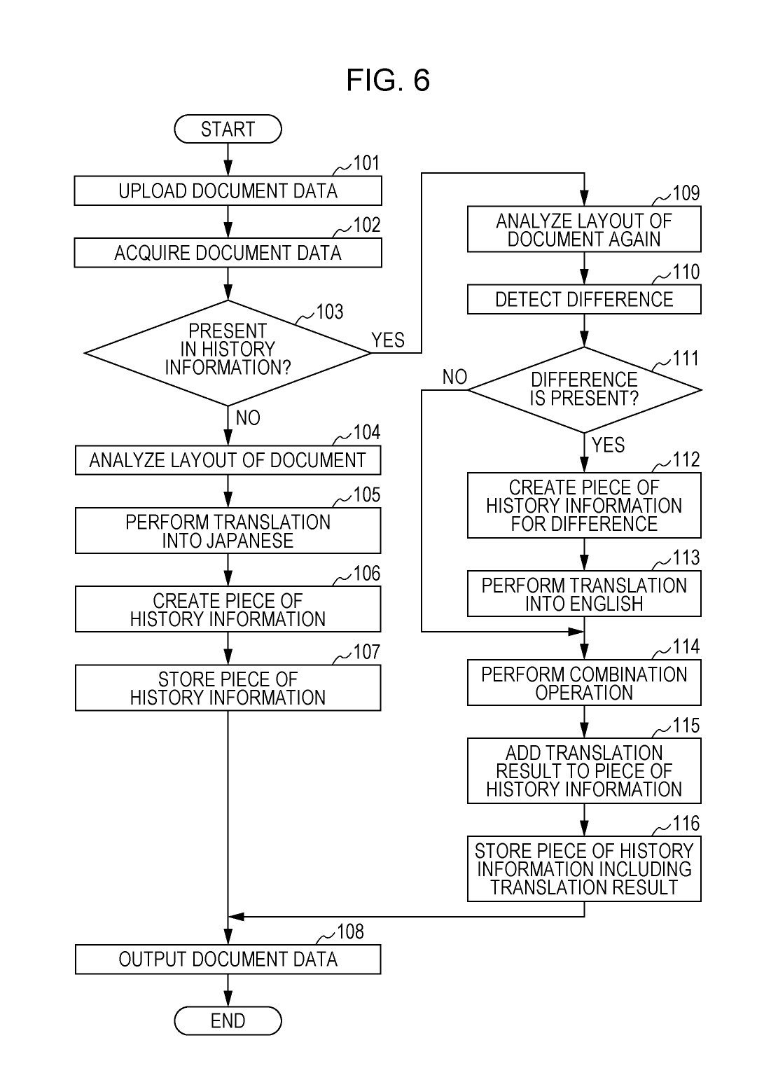

FIG. 6 is a flowchart describing operations performed in the translation system 1.

First, a user uploads, to the cloud server 50, document data of a document (document before translation) on which translation is to be performed (step 101).

When this operation is performed on the image forming apparatus 30, the user scans the document by using the image reading unit 36, and obtains image data of the document. The image data of the document is converted into document data whose format is the PDF format or the like, and the resulting document data is transmitted to the cloud server 50. It is assumed that the document data transmitted at that time is, for example, the document data of the document before translation which is illustrated in FIG. 4A.

The data acquiring unit 501 of the cloud server 50 acquires the transmitted document data as document data of a document (step 102).

Then, the determination unit 502 determines whether or not the document data acquired by the data acquiring unit 501 is present in the history information (step 103). In determination as to whether or not acquired document data is present in the history information, the determination unit 502 determines whether or not the document contains a QR code indicating a piece of history information. For example, the document illustrated in FIG. 4A does not contain a QR code. Therefore, the determination unit 502 determines that the acquired document data is new data which is not present in the history information.

If the document data acquired by the data acquiring unit 501 is new data and if the determination unit 502 determines that the document data is not present in the history information (NO in step 103), the layout analyzing unit 503 analyzes the layout of the document (step 104).

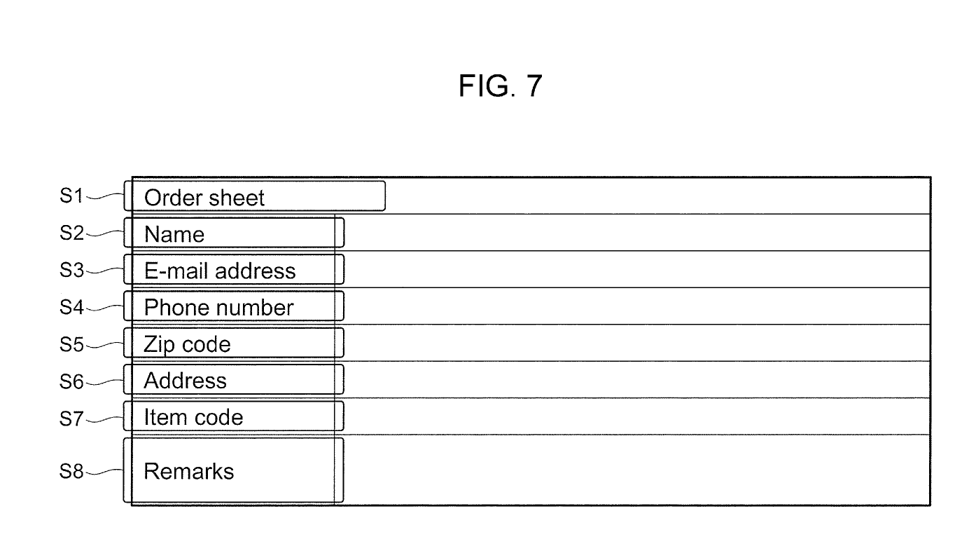

FIG. 7 is a diagram illustrating results obtained by the layout analyzing unit 503 analyzing the layout of the document.

As illustrated in FIG. 7, the layout analyzing unit 503 sets rectangular regions for portions in which text is present in the document. In the example illustrated in FIG. 7, rectangular regions S1 to S8 are set for “Order Sheet”, “Name”, “E-mail address”, “Phone number”, “Zip code”, “Address”, “Item code”, and “Remarks”, respectively. The layout analyzing unit 503 creates pieces of region information for the respective rectangular regions S1 to S8. Each of the pieces of region information includes, for example, information indicating the position of the rectangular region, text contained in the rectangular region, and the language of the text contained in the rectangular region. The information indicating the position of a rectangular region includes, for example, a start point of the rectangular region (the coordinates for the upper-left position of the rectangular region) and an end point of the rectangular region (the coordinates for the lower-right position of the rectangular region). In addition to this, a page number or the like may be included. The text contained in the rectangular region is text data, such as “Order Sheet”, “Name”, or “E-mail address” which is described above. The language of the text contained in the rectangular region is English in this case. In addition to this, information about a language into which translation is to be performed (in this case, Japanese) may be included.

Returning back to FIG. 6, the translation unit 504 uses the translation dictionary stored in the memory 505, so as to translate the content of the document from English into Japanese (step 105).

In this case, “Order Sheet”, “Name”, “E-mail address”, “Phone number”, “Zip code”, “Address”, “Item code”, and “Remarks” which are included in the pieces of region information are translated into “ [symbol] ” (Order sheet), “ [symbol] ” (Name), “ [symbol] ” (E-mail address), “ [symbol] ” (Phone number), “ [symbol] ” (Zip code), “ [symbol] ” (Address), “ [symbol] ” (Item code), and “ [symbol] ” (Remarks), respectively.

The history creating unit 506 creates a piece of history information (step 106). The piece of history information includes correspondences between original text in English and translated text in Japanese.

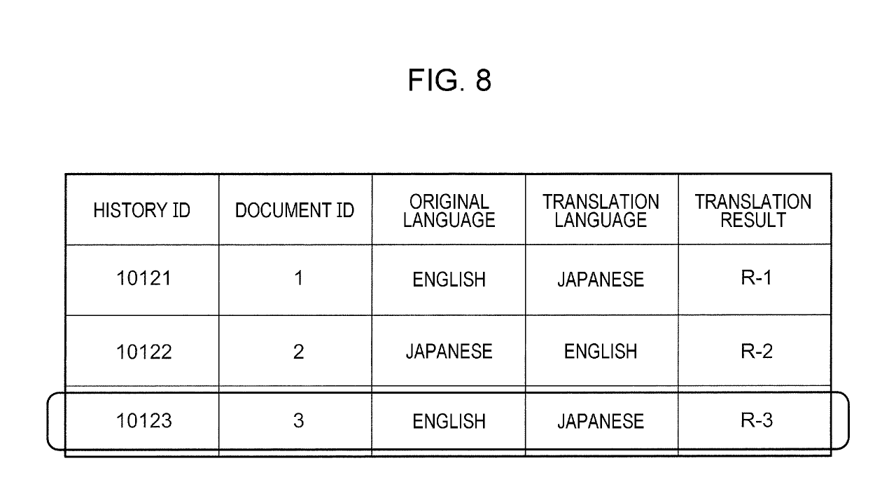

FIG. 8 is a diagram illustrating exemplary history information created by the history creating unit 506.

A piece of history information illustrated in FIG. 8 includes a history ID, a document ID, an original language, a translation language, and a translation result. An example in which pieces of history information whose history IDs are 10121 and 10122 are already stored and in which a piece of history information whose history ID is 10123 has been added this time is illustrated.

The document ID is link information. When document data whose document ID is “3” is referred to, the pieces of region information described in FIG. 7 and the image information of the document before translation may be obtained.

The translation result is also link information. When data whose translation result is “R-3” is referred to, the above-described correspondences of “Order Sheet” and “ [symbol] ”, “Name” and “ [symbol] ”, “E-mail address” and “ [symbol] ”, “Phone number” and “ [symbol] ”, “Zip code” and “ [symbol] ”, “Address” and “ [symbol] ”, “Item code” and “ [symbol] ”, and “Remarks” and “ [symbol] ” may be obtained. In addition, image information of the document after translation may be obtained. That is, a piece of history information includes correspondences between original text in English and translated text in Japanese.

Returning back to FIG. 6, the memory 505 is used to store the piece of history information (step 107).

The data output unit 509 outputs, to the image forming apparatus 30, document data of the document in Japanese after translation (step 108). At that time, the data output unit 509 embeds the history ID (in this case, 10123) as a QR code in the document data. As a result, the resulting document is the document after translation illustrated in FIG. 4B, and the user may obtain the document after translation.

Then, the user adds information for necessary items to the received document after translation. As a result, the document after the addition as illustrated in FIG. 4C is obtained.

When the user uploads the document after the addition again in order to return the document to the transmission source from which the document before translation has been transmitted, the process returns back to step 101 in the flowchart in FIG. 6. However, in step 101 and in step 103 after step 102, since the document contains a QR code indicating a piece of history information, the determination unit 502 determines that the obtained document data is present in the history information (YES in step 103). In this case, the layout analyzing unit 503 analyzes the layout of the document again (step 109).

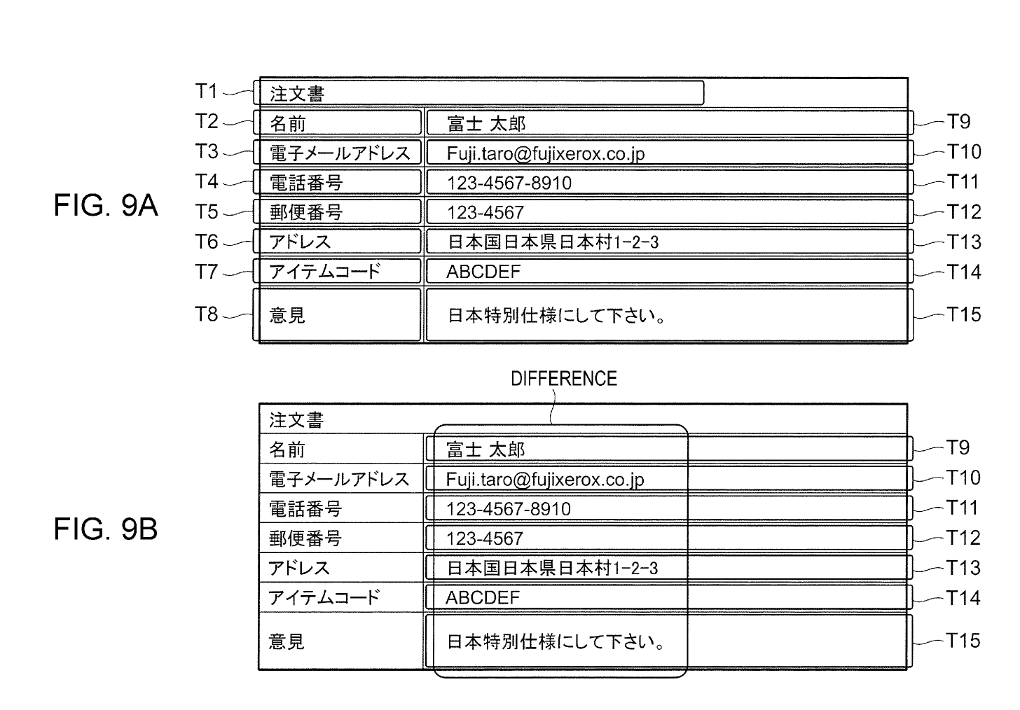

FIG. 9A is a diagram illustrating a result obtained by the layout analyzing unit 503 analyzing the layout of the document again.

Similarly to the case in FIG. 7, the layout analyzing unit 503 sets rectangular regions for portions in which text is present in the document. As a result, the layout analyzing unit 503 first sets rectangular regions for the same portions as those for the rectangular regions S1 to S8 illustrated in FIG. 7. In the example illustrated in FIG. 9A, the layout analyzing unit 503 sets rectangular regions T1 to T8 for “ [symbol] ” (Order sheet), “ [symbol] ” (Name), “ [symbol] ” (E-mail address), “ [symbol] ” (Phone number), “ [symbol] ” (Zip code), “ [symbol] ” (Address), “ [symbol] ” (Item code), and “ [symbol] ” (Remarks). Further, the layout analyzing unit 503 sets rectangular regions T9 to T15 for the portions in which the user has added information to the document. That is, the rectangular regions T9 to T15 are set for “ [symbol] ” (Taro Fuji), “Fuji.taro@fujixerox.co.jp”, “123-4567-8910”, “123-4567”, “ [symbol] 1-2-3” (1-2-3 Japan Village, Japan Prefecture, Japan), “ABCDEF”, and “ [symbol] ” (Apply a specification specific to Japan). Then, the layout analyzing unit 503 creates pieces of region information for the rectangular regions T1 to T15. The pieces of region information are similar to those described in FIG. 7.

Returning back to FIG. 6 again, the extraction unit 507 detects difference in rectangular regions between the document after translation which is illustrated in FIG. 4B and the document after the addition which is illustrated in FIG. 4C, on the basis of the pieces of region information (step 110). The difference is obtained by comparing the image of the document after translation which is obtained from the history information, with the image of the document after the addition.

FIG. 9B is a diagram illustrating the difference detected by the extraction unit 507.

In this case, the rectangular regions T9 to T15 are detected as difference. To put it another way, when content of a document in a second language (Japanese) is present in the history information, the extraction unit 507 extracts content of the document which is not present in the history information.

The extraction unit 507 determines whether or not difference is present (step 111). At that time, the case in which the extraction unit 507 determines that no difference is present (NO in step 111) is the case in which the user has not added information to the document after translation. In this case, the process proceeds to step 114.

In contrast, the case in which the extraction unit 507 determines that difference is present (YES in step 111) is the case in which the user has added information to the document after translation so as to obtain the document illustrated in FIG. 4C. In this case, the history creating unit 506 creates a piece of history information for the difference (step 112). The piece of history information includes correspondences between original text in Japanese and translated text in English.

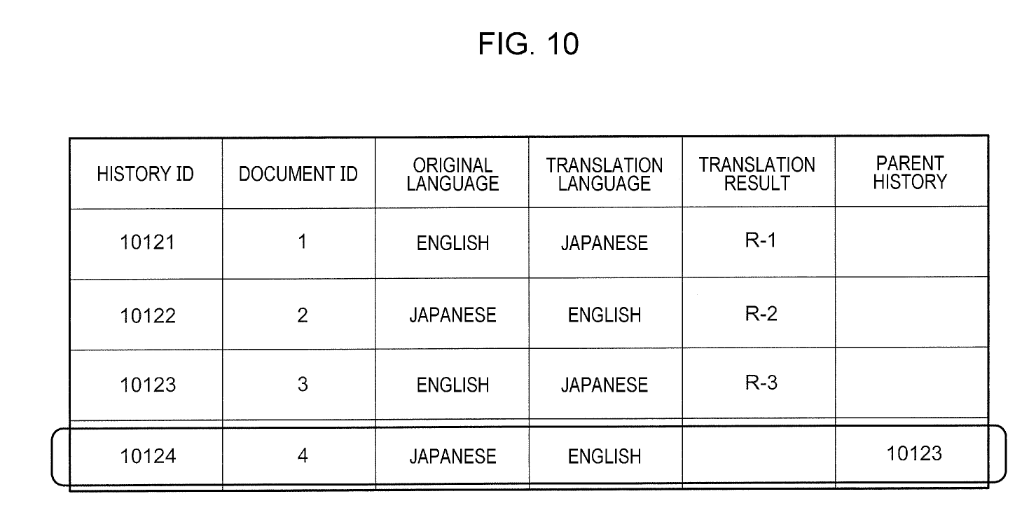

FIG. 10 is a diagram illustrating an exemplary piece of history information for the difference which is created by the history creating unit 506.

The illustrated history information includes a parent history in addition to a history ID, a document ID, an original language, a translation language, and a translation result which are illustrated in FIG. 8. An example in which data whose history ID is 10124 is added is illustrated. The document ID that is link information is “4”. When the document ID is referred to, the pieces of region information for the rectangular regions T9 to T15 may be obtained. In addition, image information of the document after the addition may be obtained. As a parent history, “10123” is described. This shows that the document whose history ID is 10124 is a document obtained by adding a difference indicated by the document ID, to the document whose history ID is 10123.

The translation unit 504 translates the text in the rectangular regions T9 to T15 which are detected as difference, from Japanese into English by using the translation dictionary stored in the memory 505 (step 113).

Specifically, “ [symbol] ” (Taro Fuji), “Fuji.taro@fujixerox.co.jp”, “123-4567-8910”, “123-4567”, “ [symbol] 1-2-3 ” (1-2-3 Japan Village, Japan Prefecture, Japan), “ABCDEF”, and “ [symbol] ” (Apply a specification specific to Japan) which are contained in the rectangular regions T9 to T15 are translated into “Fujitarou”, “Fuji.taro@fujixerox.co.jp”, “123-4567-8910”, “123-4567”, “Japan Japan prefecture Japan village 1-2-3”, “ABCDEF”, and “Make a Japanese special series.”, respectively.

The combining unit 508 combines a result of translation with a result of replacement (step 114). The result of translation is obtained by the translation unit 504 translating content that is not present in the history information, from the second language (in this case, Japanese) into a different language (in this case, English which is the first language). The result of replacement is obtained by replacing content that is present in the history information, from the second language (in this case, Japanese) to the different language (in this case, English which is the first language) on the basis of the history information. The result of translation corresponds to a result obtained by translating “ [symbol] ” (Taro Fuji), “Fuji.taro@fujixerox.co.jp”, and the like which are contained in the rectangular regions T9 to T15, into “Fujitarou”, “Fuji.taro@fujixerox.co.jp”, and the like. The result of replacement corresponds to a result obtained by replacing “ [symbol] ” (Order sheet), “ [symbol] ” (Name), and the like which are contained in the rectangular regions T1 to T8, with “Order Sheet”, “Name”, and the like.

If the determination result is NO in step 111, that is, if the user has not added information to the document after translation, only the second-mentioned process of replacing “ [symbol] ” (Order sheet), “ [symbol] ” (Name), and the like which are contained in the rectangular regions T1 to T8 with “Order Sheet”, “Name”, and the like is performed. That is, the document before translation illustrated in FIG. 4A is recovered.

The history creating unit 506 adds the translation result to the piece of history information created in step 112 (step 115).

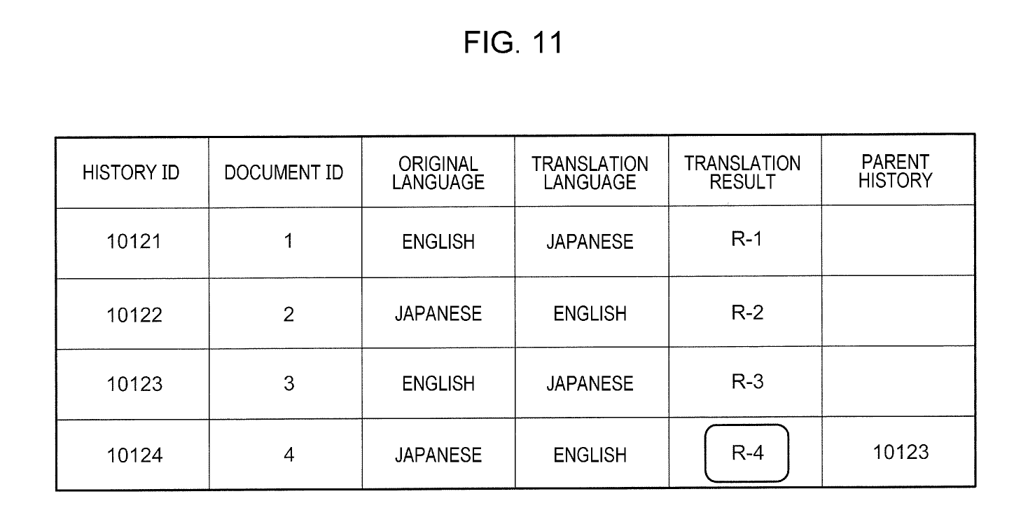

FIG. 11 is a diagram illustrating an exemplary piece of history information obtained after the history creating unit 506 adds a translation result.

Data R-4 is added as a translation result to the piece of history information illustrated in FIG. 11 in comparison with the piece of history information illustrated in FIG. 10. When the translation result R-4 is referred to, the correspondences of “ [symbol] ” and “Fujitarou”, “Fuji.taro@fujixerox.co.jp” and “Fuji.taro@fujixerox.co.jp”, “123-4567-8910” and “123-4567-8910”, “123-4567” and “123-4567”, “ [symbol] 1-2-3” and “Japan Japan prefecture Japan village 1-2-3”, “ABCDEF” and “ABCDEF”, and “ [symbol] ” and “Make a Japanese special series.” which are described above are obtained. In addition, the image of the document after combination created by the combining unit 508 is obtained.

Then, the memory 505 is used to store the piece of history information to which the translation result has been added (step 116).

The data output unit 509 outputs, to the image forming apparatus 30, the document data of the document in English after retranslation (step 108). At that time, the data output unit 509 embeds the history ID (in this case, 10124) as a QR code in the document data that is to be output. As a result, the document after retranslation illustrated in FIG. 4D is obtained, and the user may obtain the document after retranslation.

The above-described exemplary embodiment may be applied to a case in which the combining unit 508 uses a language other than English as a language into which retranslation is performed. For example, it is assumed that a language into which retranslation is performed is French which is a third language. In this case, the combining unit 508 combines a result of translation with a result of replacement. The result of translation is obtained by the translation unit 504 translating content that is not present in the history information, from the second language (in this case, Japanese) into the third language (in this case, French). The result of replacement is obtained by, on the basis of the history information, translating content that is present in the history information, from the first language (in this case, English) into the third language (in this case, French) and replacing the content with the result. That is, the result of translation is obtained by translating Japanese text into French text, whereas the result of replacement is obtained by translating original English text into French text on the basis of the history information. That is, text in an original document before translation is subjected to a single translating operation from English into French, not to two translating operations from English via Japanese into French. As a result, difference between the meaning of original English text and that of French text after translation hardly arises.

In the above-described exemplary embodiment, in determination as to whether or not obtained document data is present in the history information, the determination unit 502 determines whether or not the document contains a QR code indicating a piece of history information. This is not limiting. Instead of a QR code, a barcode or the like may be used.

Alternatively, identification information, such as a QR code and a barcode, is not limiting. For example, when document data is a structured document, a piece of history information may be embedded as data. Alternatively, a piece of history information may be set as a file property of document data. Further, presence of a piece of history information may be determined from similarity of the layout of text.

In the above-described example, the cloud server 50 is connected to the network 70, and provides a cloud service. Alternatively, the cloud server 50 may be connected to the network 90, and may be used as a translation server. That is, a network connected to the cloud server 50 is not particularly limited. Further, the functions of the cloud server 50 may be provided by the image forming apparatus 30, and the image forming apparatus 30 alone may perform the series of processes. In this case, the image forming apparatus 30 serves as a translation apparatus.

Description about Programs

The processes performed by the cloud server 50 in the exemplary embodiment are performed, for example, by the CPU 11 loading various programs stored in the HDD 13 or the like, onto the main memory 12 and executing the programs.

The processes performed by the cloud server 50 may be regarded as a program for implementing the following functions: translating content of a document into a different language; when the content of the document is translated from a first language into a second language, creating history information including a correspondence between original text in the first language and translated text in the second language; when the content of the document is to be translated from the second language into another language, if content of the document written in the second language is present in the history information, extracting content that is not present in the history information; and combining a result of translation with a result of replacement, the result of translation being obtained by translating the content that is not present in the history information, the translating being performed from the second language into the other language, the result of replacement being obtained by replacing the content that is present in the history information, the replacing being performed from the second language to the other language on a basis of the history information.

The program for implementing the exemplary embodiment may be provided not only through a communication unit but also thorough a recording medium such as a compact disc-read-only memory (CD-ROM) storing the program.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A translation apparatus comprising:
a translation unit that translates content of a document into a different language;
a history creating unit that, when the translation unit translates the content of the document from a first language into a second language, creates history information including a correspondence between original text in the first language and translated text in the second language;
an extraction unit that, when the translation unit is to translate the content of the document from the second language into another language, if content of the document written in the second language is present in the history information, extracts content that is not present in the history information; and
a combining unit that combines a result of translation with a result of replacement, the result of translation being obtained by the translation unit translating the content that is not present in the history information, the translating being performed from the second language into the other language, the result of replacement being obtained by replacing the content that is present in the history information, the replacing being performed from the second language to the other language on a basis of the history information.

2. The translation apparatus according to claim 1,
wherein the other language is the first language, and
wherein the combining unit combines the result of translation with the result of replacement, the result of translation being obtained by the translation unit translating the content that is not present in the history information, the translating being performed from the second language into the first language, the result of replacement being obtained by replacing the content that is present in the history information, the replacing being performed from the second language to the first language on a basis of the history information.

3. The translation apparatus according to claim 1,
wherein the other language is a third language that is different from the first language and the second language, and
wherein the combining unit combines the result of translation with the result of replacement, the result of translation being obtained by the translation unit translating, from the second language into the third language, the content that is not present in the history information, the result of replacement being obtained by translating, for replacement, the content that is present in the history information, from the first language into the third language on a basis of the history information.

4. The translation apparatus according to claim 1,
wherein the content that is not present in the history information is about an item that has been added to the document by a user.

5. The translation apparatus according to claim 2,
wherein the content that is not present in the history information is about an item that has been added to the document by a user.

6. The translation apparatus according to claim 3,
wherein the content that is not present in the history information is about an item that has been added to the document by a user.

7. The translation apparatus according to claim 1, further comprising:
a layout analyzing unit that analyzes a layout of the document,
wherein the translation unit and the combining unit maintain the layout obtained through the analysis performed by the layout analyzing unit, and arrange a translation result.

8. The translation apparatus according to claim 2, further comprising:
a layout analyzing unit that analyzes a layout of the document,
wherein the translation unit and the combining unit maintain the layout obtained through the analysis performed by the layout analyzing unit, and arrange a translation result.

9. The translation apparatus according to claim 3, further comprising:
a layout analyzing unit that analyzes a layout of the document,
wherein the translation unit and the combining unit maintain the layout obtained through the analysis performed by the layout analyzing unit, and arrange a translation result.

10. The translation apparatus according to claim 4, further comprising:
a layout analyzing unit that analyzes a layout of the document,
wherein the translation unit and the combining unit maintain the layout obtained through the analysis performed by the layout analyzing unit, and arrange a translation result.

11. The translation apparatus according to claim 5, further comprising:
a layout analyzing unit that analyzes a layout of the document,
wherein the translation unit and the combining unit maintain the layout obtained through the analysis performed by the layout analyzing unit, and arrange a translation result.

12. The translation apparatus according to claim 6, further comprising:
a layout analyzing unit that analyzes a layout of the document,
wherein the translation unit and the combining unit maintain the layout obtained through the analysis performed by the layout analyzing unit, and arrange a translation result.

13. The translation apparatus according to claim 7,
wherein the extraction unit extracts the content that is not present in the history information, on a basis of a position of a target to be translated, the position being obtained through the analysis performed by the layout analyzing unit.

14. The translation apparatus according to claim 8,
wherein the extraction unit extracts the content that is not present in the history information, on a basis of a position of a target to be translated, the position being obtained through the analysis performed by the layout analyzing unit.

15. The translation apparatus according to claim 9,
wherein the extraction unit extracts the content that is not present in the history information, on a basis of a position of a target to be translated, the position being obtained through the analysis performed by the layout analyzing unit.

16. The translation apparatus according to claim 10,
wherein the extraction unit extracts the content that is not present in the history information, on a basis of a position of a target to be translated, the position being obtained through the analysis performed by the layout analyzing unit.

17. The translation apparatus according to claim 11,
wherein the extraction unit extracts the content that is not present in the history information, on a basis of a position of a target to be translated, the position being obtained through the analysis performed by the layout analyzing unit.

18. The translation apparatus according to claim 12,
wherein the extraction unit extracts the content that is not present in the history information, on a basis of a position of a target to be translated, the position being obtained through the analysis performed by the layout analyzing unit.

19. A translation system comprising:
a translation section that translates content of a document; and
a document transmitting section that transmits, to the translation section, document data of the document written in an original language,
wherein the translation section includes
a translation unit that translates the content of the document into a different language,
a history creating unit that, when the translation unit translates the content of the document from a first language into a second language, creates history information including a correspondence between original text in the first language and translated text in the second language,
an extraction unit that, when the translation unit is to translate the content of the document from the second language into another language, if content of the document written in the second language is present in the history information, extracts content that is not present in the history information, and
a combining unit that combines a result of translation with a result of replacement, the result of translation being obtained by the translation unit translating the content that is not present in the history information, the translating being performed from the second language into the other language, the result of replacement being obtained by replacing the content that is present in the history information, the replacing being performed from the second language to the other language on a basis of the history information.

20. A non-transitory computer readable medium storing a program causing a computer to execute a process comprising:
translating content of a document into a different language;
when the content of the document is translated from a first language into a second language, creating history information including a correspondence between original text in the first language and translated text in the second language;
when the content of the document is to be translated from the second language into another language, if content of the document written in the second language is present in the history information, extracting content that is not present in the history information; and
combining a result of translation with a result of replacement, the result of translation being obtained by translating the content that is not present in the history information, the translating being performed from the second language into the other language, the result of replacement being obtained by replacing the content that is present in the history information, the replacing being performed from the second language to the other language on a basis of the history information.
